(19) United States
(12) Patent Application Publication
(10) Pub. No.: US 2021/0332960 A1
(43) Pub. Date: Oct. 28, 2021

(54) STRUCTURE FOR MOUNTING A WALL LAMP

(71) Applicant: GUANGDONG OML TECHNOLOGY CO., LTD., Zhongshan City (CN)

(72) Inventor: Xiaobing LI, ZHONGSHAN CITY (CN)

(21) Appl. No.: 16/330,459

(22) PCT Filed: Dec. 28, 2018
(86) PCT No.: PCT/CN2018/124635

§ 371 Date: Mar. 5, 2019

(30) Foreign Application Priority Data
Dec. 13, 2018 (CN) 201822095851.5

(51) Int. Cl. F21S 8/00; F21V 17/16; F21V 23/00

(52) U.S. Cl. CPC F21S 8/036; F21V 23/001; F21V 17/16

(57) ABSTRACT

Disclosed is a structure for mounting a wall lamp, comprising a wall lamp body and a wall frame, wherein the wall lamp body is configured for hanging on the wall frame through a snap-fitting structure. With this structure, it is convenient to assemble and disassemble the wall lamp body, and the disassembly/assembly efficiency of the wall lamp can be improved.

### FIELD

The present disclosure relates to a wall lamp and in particular to a structure for mounting a wall lamp.

### BACKGROUND

A wall lamp is a lamp hung on the wall, which can be used for illumination and decoration, and is more and more widely mounted in places such as homes. At present, wall lamps are mostly mounted by screws. That is, screws pass through a wall lamp from front to rear and then are locked on a wall frame. The mounting process is relatively tedious, and the screws will affect the overall beauty of the wall lamp. When the wall lamp needs to be disassembled or replaced, an operator needs to disassemble or assemble the wall lamp by a screwdriver. Consequently, the whole disassembly/assembly process is relatively tedious, and the operating efficiency is reduced.

### SUMMARY

In order to solve the above problems, the present disclosure provides a structure for mounting a wall lamp, which is easy to disassemble/assemble.

To solve the technical problem, the present disclosure employs the following technical solutions.

A structure for mounting a wall lamp, comprising a wall lamp body and a wall frame, wherein the wall lamp body is configured for hanging on the wall frame through a snap-fitting structure.

Preferably, the snap-fitting structure comprises a hinging groove and a hinging lug which are matched with each other; one of the hinging groove and the hinging lug is arranged on a rear side of the wall lamp body, and the other one of the hinging groove and the hinging lug is arranged on a front side of the wall frame; and, the wall lamp body is longitudinally movable relative to the wall frame to insert the hinging lug into the hinging groove.

Preferably, the hinging groove is provided, at an upper end of the hinging groove, with a turnup inclined to an inner sidewall of the hinging groove.

Preferably, the hinging lug is provided, at a lower end of the hinging lug, with an inclined guide transition. Preferably, the hinging groove is provided, at a lower end of the hinging groove, with a first stop tab, or the hinging lug is provided, at an upper end of the hinging lug, with a second stop tab.

Preferably, a positioning projection is arranged on a sidewall of one of the hinging lug and the hinging groove, a positioning hole is arranged on a sidewall of the other one of the hinging lug and the hinging groove, and the positioning projection is configured to be placed into the positioning hole when the hinging lug is inserted into the hinging groove.

Preferably, the wall lamp body is provided with a first spacer abutted against the wall frame on a rear side of the wall lamp body, or the wall frame is provided with a second spacer abutted against the wall lamp body on a front side of the wall frame.

Preferably, the wall frame is provided with a mounting position for mounting a horizontal bead.

Preferably, the wall lamp body is provided, on a rear side of the wall lamp body, with a mounting plate configured for hanging on the wall frame through the snap-fitting structure.

Preferably, the mounting plate is provided with a wire passageway, and the wall frame is provided with a mounting port communicated with the wire passageway.

The present disclosure has the following beneficial effects: in the present disclosure, a wall lamp body is hung on a wall frame through a snap-fitting structure, so it is convenient to assemble and disassemble the wall lamp body, and the disassembly/assembly efficiency of a wall lamp can be improved.

### BRIEF DESCRIPTION OF THE DRAWINGS

The present disclosure will be further described below by embodiments with reference to the accompanying drawings.

FIG. 1 is a schematic diagram of connection between a wall lamp body and a wall frame;

FIG. 2 is a schematic structural diagram after the wall lamp body is separated from the wall frame;

FIG. 3 is a schematic structural diagram of a mounting plate;

FIG. 4 is a schematic diagram of connection between the wall frame and a terminal box; and

FIG. 5 is a schematic diagram of connection between the mounting plate and the wall frame.

### DETAILED DESCRIPTION OF THE EMBODIMENTS

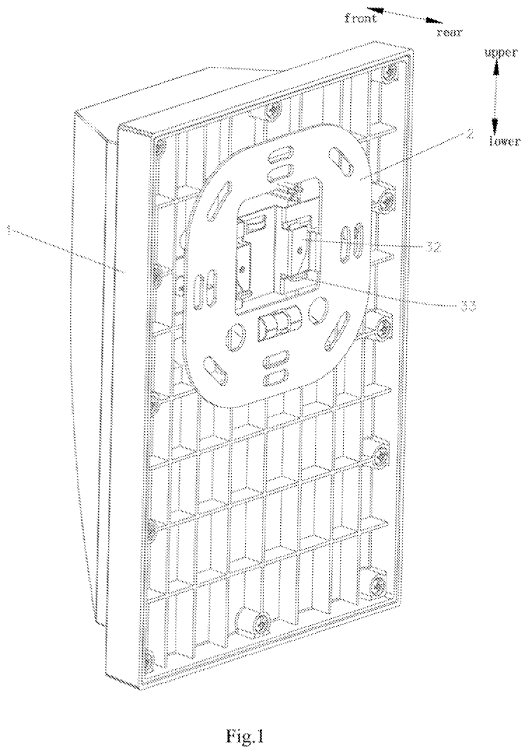

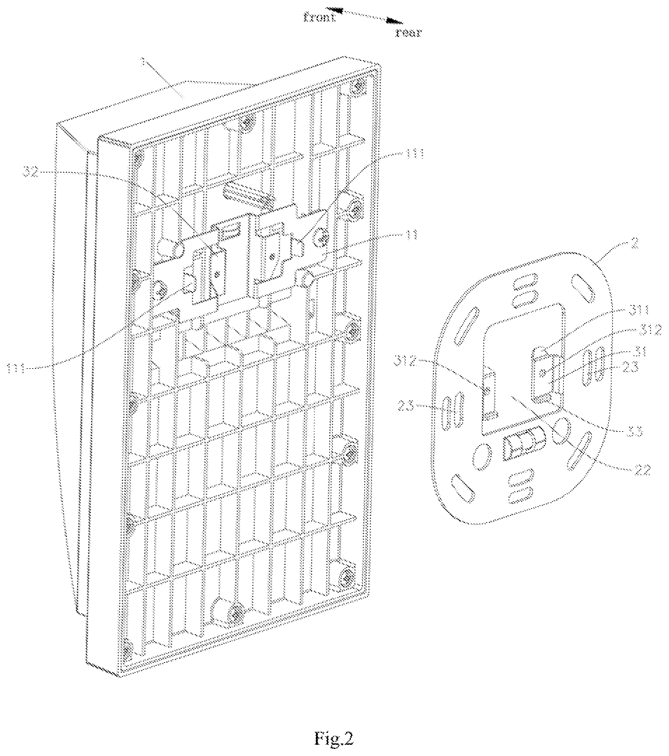

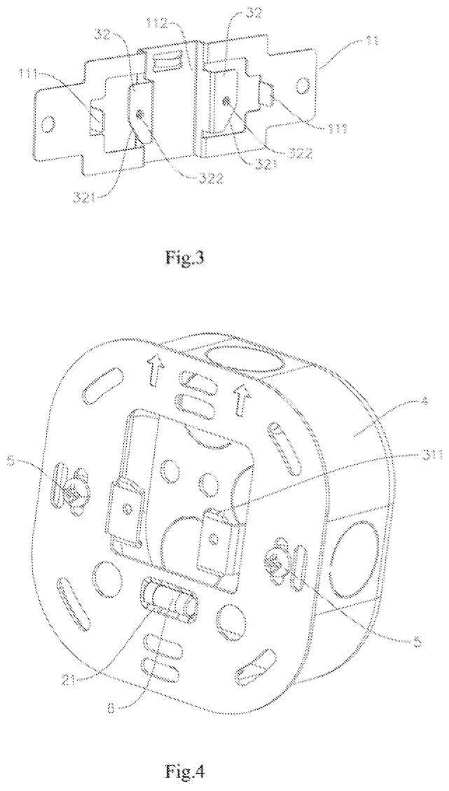

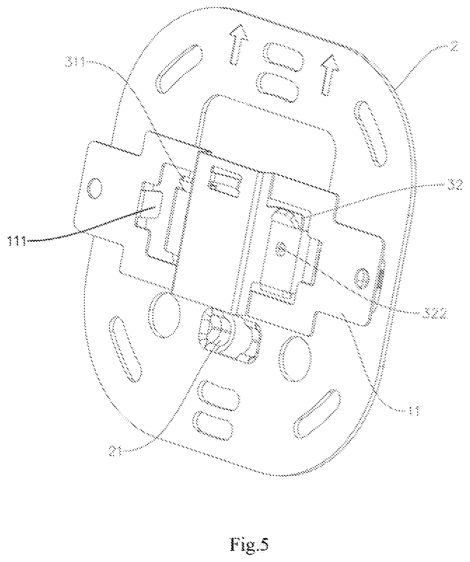

Referring to FIGS. 1-5, the present disclosure provides a structure for mounting a wall lamp, including a wall lamp body 1 and a wall frame 2. The wall lamp body 1 is hung on the wall frame 2 through a snap-fitting structure.

Specifically, the snap-fitting structure includes a hinging groove 31 and a hinging lug 32 which are matched with each other. The hinging groove 31 is arranged on a front side of the wall frame 2, and the hinging lug 32 is arranged on a rear side of the wall lamp body 1. The wall lamp body 1 is longitudinally movable relative to the wall frame 2 such that the hinging lug 32 is insertable into the hinging groove 31. In this way, the wall lamp body 1 can be hung on the wall frame 2. Of course, it is also possible that the hinging groove 31 is arranged on the rear side of the wall lamp body 1 and the hinging lug 32 is arranged on the front side of the wall frame 2.

Preferably, there are two set of snap-fitting structures which are arranged symmetrically.

A turnup 311 inclined to an inner sidewall of the hinging groove 31 is provided at an upper end of the hinging groove 31. The turnup 311 may play a guiding role, so that the hinging lug 31 may slide into the hinging groove 31 along the turnup 311.

The hinging lug 32 is provided at a lower end thereof with an inclined guide transition 321 for facilitating arrangement of the hinging lug 32 into the hinging groove 31.

A first stop tab 33 is provided at a lower end of the hinging groove 31, and the lower end of the hinging lug 32 is abutted against the first stop tab 33, so that the hinging lug 32 is positioned and prevented from sliding downward. It is also possible that a second stop tab is provided at an upper end of the hinging lug and the second stop tab is abutted against an upper end of the hinging groove 31 so that the hinging lug 32 is positioned and prevented from sliding downward.

A first spacer abutted against the wall frame 2 is provided on a rear side of the wall lamp body 1. With this structure, a proper distance is maintained between the wall lamp body 1 and the wall frame 2, so that the sidewall of the hinging lug 32 is closely fitted to the inner sidewall of the hinging groove 31 so as to avoid the relative movement between the hinging lug 32 and the hinging groove 31. Of course, it is also possible that a second spacer abutted against the wall lamp body 1 is provided on the front side of the wall frame 2.

A positioning projection 322 is provided on a sidewall of one of the hinging lug 32 and the hinging groove 31, and a positioning hole 312 is arranged on a sidewall of the other one of the hinging lug 32 and the hinging groove 31. The positioning projection 311 is placed into the positioning hole 312 when the hinging lug 32 is inserted into the hinging groove 31, so that the relative movement between the hinging lug 32 and the hinging groove 31 can be limited, and the hinging lug 32 can be prevented from sliding downward.

A mounting position 21 for mounting a horizontal bead 6 is provided on the wall frame 2. The use of the mounting position 21 for mounting a horizontal bead 6 is beneficial for horizontal adjustment and facilitates horizontal positioning of the wall lamp body 1.

In the present disclosure, a mounting plate 11 is provided on the rear side of the wall lamp body 1, and is hung on the wall frame 2 through the snap-fitting structure. Both the hinging lug 32 and the first spacer III are both sheet-shaped, and the mounting plate 11 is formed by bending a sheet material, so that the structure can be simplified.

Similarly, the wall frame 2 is plate-shaped. The structure of the wall frame 2 is also formed by bending a sheet material.

A wire passageway 112 is provided on the mounting plate 11, and a mounting port 22 communicated with the wire passageway 112 is arranged on the wall frame 2, so that it is convenient to accommodate a power wire harness drawn out from the wall lamp body 1.

During the mounting and use, the wall frame 2 is mounted on a terminal box 4, and the dimension of the outer contour of the wall frame 2 is greater than that of the outer contour of the terminal box 4. In this way, it is advantageous for limiting after the wall frame 2 is mounted on the terminal box 4.

Specifically, the wall frame 2 is locked on the terminal box 4 by a fastening screw 5; a straight slot 23 for allowing a rod portion of the fastening screw 5 to pass therethrough is arranged on the wall frame 2, and the length of the straight slot 23 is greater than the diameter of the rod portion of the fastening screw 5; and the fastening screw 5 passes through the straight slot 23 and is then locked on the terminal box 4. With this structure and in combination with the horizontal bead 6, it may be convenient to longitudinally adjust the wall frame 2 so as to keep the wall frame 2 horizontal. In addition, the wall frame 2 may also be directly mounted on a wall surface or other mounting surfaces.

The wall lamp body 1 includes a housing within which an LED light source module and a drive control device are provided. A power wire harness is drawn out from the drive control device. The power wire harness passes through the housing and is eventually electrically connected to a wiring terminal or an electric wire in the terminal box 4.

In the description of the present disclosure, the orientation or position terms such as “upper”, “lower”, “front”, “rear” or the like are defined with reference to the accompanying drawings, which are merely for facilitating and simplifying the description of the present disclosure rather than indicating or implying that the specified component must have a particular orientation or be constructed and operated in a particular orientation. Therefore, the terms should not be interpreted as limitations to the present disclosure.

The foregoing embodiments are merely preferred embodiments of the present disclosure, and other embodiments of the present disclosure are also possible. Equivalent modifications or substitutions can be made by those skilled in the art without departing from the principle of the present disclosure, and these equivalent modifications or substitutions shall fall into the scope defined by the claims of the present application.

1. A structure for mounting a wall lamp, comprising a wall lamp body and a wall frame, wherein the wall lamp body is configured for hanging on the wall frame through a snap-fitting structure.

2. The structure for mounting a wall lamp according to claim 1, wherein:
the snap-fitting structure comprises a hinging groove and a hinging lug which are matched with each other;
one of the hinging groove and the hinging lug is arranged on a rear side of the wall lamp body, and the other one of the hinging groove and the hinging lug is arranged on a front side of the wall frame; and
the wall lamp body is longitudinally movable relative to the wall frame to insert the hinging lug into the hinging groove.

3. The structure for mounting a wall lamp according to claim 2, wherein the hinging groove is provided, at an upper end of the hinging groove, with a turnup or flange inclined to an inner sidewall of the hinging groove.

4. The structure for mounting a wall lamp according to claim 2, wherein the hinging lug is provided, at a lower end of the hinging lug, with an inclined guide transition.

5. The structure for mounting a wall lamp according to claim 2, wherein the hinging groove is provided, at a lower end of the hinging groove, with a first stop tab, or the hinging lug is provided, at an upper end of the hinging lug, with a second stop tab.

6. The structure for mounting a wall lamp according to claim 2, wherein a positioning projection is arranged on a sidewall of one of the hinging lug and the hinging groove, a positioning hole is arranged on a sidewall of the other one of the hinging lug and the hinging groove, and the positioning projection is configured to be placed into the positioning hole when the hinging lug is inserted into the hinging groove.

7. The structure for mounting a wall lamp according to claim 1, wherein the wall lamp body is provided with a first spacer abutted against the wall frame on a rear side of the wall lamp body, or the wall frame is provided with a second spacer abutted against the wall lamp body on a front side of the wall frame.

8. The structure for mounting a wall lamp according to claim 1, wherein the wall frame is provided with a mounting position for mounting a horizontal bead.

9. The structure for mounting a wall lamp according to claim 1, wherein the wall lamp body is provided, on a rear side of the wall lamp body, with a mounting plate configured for hanging on the wall frame through the snap-fitting structure.

10. The structure for mounting a wall lamp according to claim 9, wherein the mounting plate is provided with a wire passageway, and the wall frame is provided with a mounting port communicated with the wire passageway.

11. The structure for mounting a wall lamp according to claim 2, wherein the wall lamp body is provided with a first spacer abutted against the wall frame on a rear side of the wall lamp body, or the wall frame is provided with a second spacer abutted against the wall lamp body on a front side of the wall frame.
